(19) United States
(12) Patent Application Publication
(10) Pub. No.: US 2013/0083185 A1
(43) Pub. Date: Apr. 4, 2013

(54) OPTICAL ADAPTER FOR OPHTHALMOLOGICAL IMAGING APPARATUS

(71) Applicant: Intuitive Medical Technologies, LLC, Shreveport, LA (US)

(72) Inventor: Wyche T. Coleman, III, Shreveport, LA (US)

(73) Assignee: INTUITIVE MEDICAL TECHNOLOGIES, LLC, Shreveport, LA (US)

(21) Appl. No.: 13/632,140

(22) Filed: Sep. 30, 2012

Related U.S. Application Data
(60) Provisional application No. 61/541,105, filed on Sep. 30, 2011.

(51) Int. Cl. H04N 7/18

(52) U.S. Cl. 348/78; 348/E07.085

(57) ABSTRACT

An optical adapter system for a smart-phone has a lens and a light transmission guide within a housing. The adapter lens is located at the distal end of the housing in optical alignment with the smart-phone's camera lens, and the light transmission guide extends from one end that is adjacent to the smart-phone's light source toward the distal end of the housing and directs light outside of the housing to the subject being imaged. The optical adapter is preferably used in combination with the smart-phone as an ophthalmic examination tool and can be used with a computer program that runs on the smart-phone's processor. The computer program can be calibrated for use with the particular optical adapter and can be used to control the smart-phone's imaging system, such as varying the intensity of the light source, and can determine a refractive error in a patient's eye.

### CROSS-REFERENCE TO RELATED APPLICATIONS

This application claims priority from U.S. Provisional Patent Application Ser. No. 61/541,105 filed on Sep. 30, 2011 which is hereby incorporated by reference.

### STATEMENT REGARDING FEDERALLY SPONSORED RESEARCH

Not Applicable.

### APPENDIX Not Applicable.

### BACKGROUND OF THE INVENTION

1. Field of the Invention

The present invention relates to ophthalmoscopes, and more particularly to imaging devices and computer systems used in combination with ophthalmoscopes.

2. Related Art

Current handheld ophthalmoscopes available to most primary-care physicians (non-eye specialists) can be bulky and cumbersome because of the battery packs which can be six (6) inches long and weigh one-half (½) pound. Ophthalmoscopes can also be expensive, especially when they are combined with an imaging system and a specialized computer processing system. Some recent advances seek to combine ophthalmoscopes with mobile phones which have their own imaging and display systems and computer processors as well as connectivity through mobile communications networks (referred to in the vernacular as smart-phones). These combined ophthalmoscope/smart-phone devices may be able to provide lower cost systems with satisfactory quality for the majority of primary-care physicians and for healthcare professionals performing telemedicine in remote locations but still typically require the ophthalmoscope to maintain its own battery pack and light source and remain rather bulky.

Another recent advance is the combination of an optical adapter to a standard camera to transform the camera into a fundus camera, such as disclosed in U.S. patent application Ser. No. 13/525,598 which is hereby incorporated by reference. This adapter can also lower the cost of a basic fundus camera system with satisfactory image quality. However, the proposed adapter is designed to be used with cameras which have their own predefined imaging settings and that must be connected to a separate computer for any processing of the image. Therefore, the ordinary camera adapter cannot use specialized software that works with the processor of the camera to optimize the operation of the camera for the particular imaging being performed nor can it provide the clinician with any guidance on performing examinations associated with the imaging or any data entry screens for taking notes on the examinations.

The capability and utility of high-resolution smart-phone cameras to perform quality fundus photography at a low cost has been demonstrated by the iExaminer system which is an adapter that the inventor of the present invention had created to mate an existing ophthalmoscope to a standard smart-phone design. The iExaminer system still has the drawback of using bulky power supplies because it is a smart-phone adapter to an existing ophthalmoscope, preferably Welch Allyn's PanOptic™ ophthalmoscope.

Accordingly, what is still needed is an adapter for a smart-phone which will allow the smart-phone to serve as a standalone ophthalmoscope and/or fundus camera that uses its own light source in combination with its optics system, its local computer processor and its communications network connectivity that allow the primary-care health provider to draw from other available resources, such as specialized physicians (ophthalmologists), database information and specialized computer programs and image processing powers.

### SUMMARY OF THE INVENTION

The present invention is a modular optical adapter system which can be used with the camera system and computer processor of a smart-phone to transform the smart-phone into a specialized medical viewing and examination device with communications connectivity, the entire combination generally referred to herein as a smart-scope system. The optical adapter system generally includes the physical structure of the optical adapter fitting and the corresponding adapter software which optimizes the use of the fitting with the smart-phone.

The optical adapter fitting has a housing that is attachable to the smart-phone and contains an objective lens in optical alignment with the lens of the smart-phone's camera system and also contains a light transmission guide which focuses the light from the smart-phone's camera system and directs the light onto the subject being viewed through the objective lens. The light transmission guide could include several optional components, such as one or more fiber optic cables, lenses, and/or minors. The optical adapter fitting may also include an image optimization lens that is adjacent to the camera system's lens.

The adapter software can control the smart-phone's camera system to capture multiple images in series over a period of time and can also lower the intensity of the camera system's light while the user aligns the imaging system with the subject being imaged and can increase the light while the images are being captured. The software may also provide the clinician with a procedures guide for performing examinations associated with the images being captured. The procedures guide may include record keeping fields and other data storage options for the examination and may also link the clinician's examination record and notes with the patient's electronic medical record. The software can use the smart-phone's connectivity over communications networks to securely pull patient information from a more comprehensive database of patient records as well as upload the examination information directly to the database.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings. The drawings constitute a part of this specification and include exemplary embodiments of the ophthalmological imaging apparatus, which may be embodied in various forms. It is to be understood that in some instances, various aspects of the invention may be shown exaggerated or enlarged to facilitate an understanding of the invention; therefore the drawings are not necessarily to scale. In addition, in the embodiments depicted herein, like reference numerals in the various drawings refer to identical or near identical structural elements.

FIG. 1 shows a cross-section of an optical adapter attached to a smart-phone to form an ophthalmologic viewing and examination instrument according to the present invention.

FIGS. 2A-2D show cross-sections of optical adapters with various optical arrangements.

FIG. 3 shows a smart-scope system being used in a communications network.

FIG. 4 shows control menus for use with the smart-scope system.

FIGS. 5A-5C shows the use of the smart-scope system in guiding a practitioner through an eye examination.

### DETAILED DESCRIPTION OF THE PREFERRED EMBODIMENTS

The following description of the preferred embodiment(s) is merely exemplary in nature and is in no way intended to limit the invention, its application, or uses.

The present invention is an optical adapter 10 which is fitted to the smart-phone 110 or other mobile communication/computation device 100. Many smart-phones 110, such as the iPhone, Android and BlackBerry, and other and other mobile communication/computation devices 100, such as tablet computers 100′ and PDAs, incorporate a high resolution camera system which includes their own lens system 112 that can include a focusing lens for various distances, as well as energy-efficient light sources 114, such as light emitting diode (LED) technologies. The LED systems that are now standard on most of these smart-phones have adequate brightness and intensity to effectively illuminate the retina of a patient if focused properly. By integrating the optical adapter with the imaging features of the smart-phones or other mobile communication/computation devices, these systems can eliminate the bulky power supplies for incandescent light sources that are needed in a number of medical scope systems while simultaneously eliminating the need for viewing the patient's anatomical features through a viewport because the user can view a live subject view 144a of the patient 200 on the smart-phone's display screen 116.

As particularly described herein, the optical adapter 10 is integrated with the smart-phone 110 to perform many of the examinations that are currently performed by standard ophthalmoscopes to view the patient's retina and can capture images of the patient's fundus similar to a standard fundus camera. According to the present invention, integrating the use of the of smart-phone's camera system, including the light source 114, with the optical adapter 10 liberates the healthcare practitioner from the burden to carry the current industry standard power supplies and provides non-eye specialists with a method of non-mydriatic or mydriatic fundus photography at an extremely low cost. Additionally, as discussed in detail below, the computer processor 118 and/or the communications module 120 of the smart-phone 110 or other mobile communication/computation device 100 can optimize the integration of the optical adapter 10 with the mobile communication and computation systems to produce a smart-scope system 140.

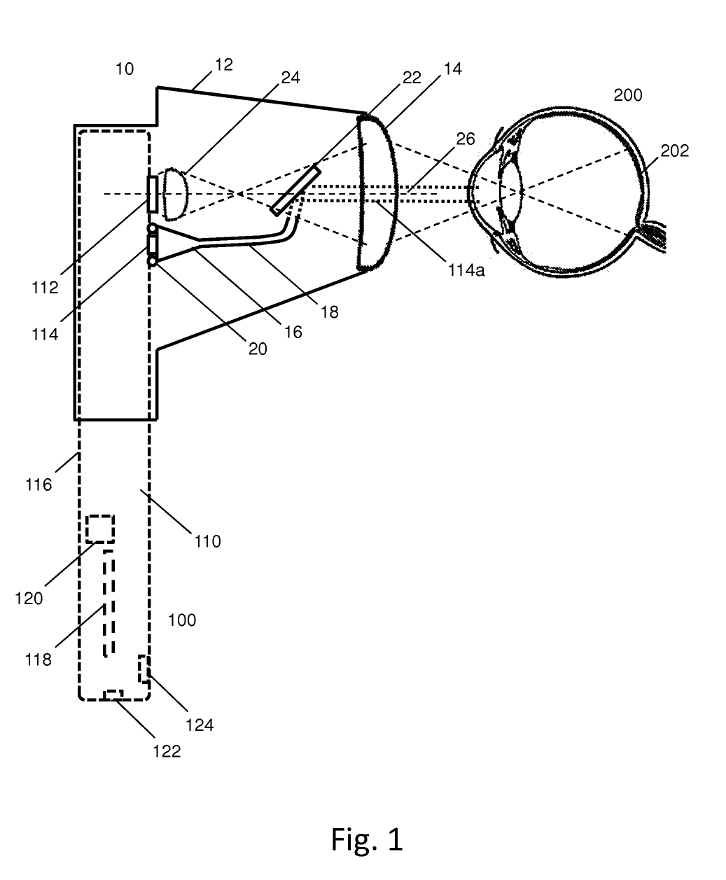

As shown in FIG. 1, the optical adapter 10 preferably has a simple lens system 14, 24 that is mounted into a housing 12 which is removably attached to the smart-phone 110. The attachment of the housing 12 to the smart-phone 110 aligns the lens system 14, 24 in the housing 12 with the optical axis 26 of the camera lens 112 on the smart-phone 110. The preferred lens system of the optical adapter may use two or more lenses, and as described below, a single lens may alternatively be used.

The optical adapter 10 can attach to the smart-phone 110 through a snap-fit connection, a sliding arrangement or any other mechanism in which the housing 12 is secured to the smart-phone. The adapter housing 12 surrounds the camera lens 112 and the light source 114 and extends out to hold the distal lens 14. The adapter housing 12 also extends around the top and one or both sides of the smart-phone case and may have tabs on the display screen side of the smart-phone. The adapter's sides and tabs are generally designed to form a slotted arrangement which holds the adapter in a fixed position relative to the smart-phone's camera lens without blocking the screen 116. The adapter is removably attached to the smart-phone, allowing it to be attached when the optics system is being used and detached when the optics system is not being used. Other types of secure and removable attachment arrangements could be used to fix the adapter to the smart-phone without departing from the present invention.

The lens system has an objective lens 14 which has a convex anterior surface and a concave posterior surface to reduce internal refractions within the housing. The posterior surface of the objective lens 14 may benefit from an antireflective coating which may reduce glare from the camera's light source 114 which is directed out of the housing by a light transmission guide 16. An additional image optimization lens 24 may be fitted in the housing at a location that is closer to the smart-phone's camera lens to ensure that the image fills the front of the imaging sensor chip in the smart-phone's camera system. This image optimization lens may be fixed in a position that is adjacent to the smart-phone lens to maximize the pixel resolution. Generally, the camera lens replaces the eyepiece of a traditional ophthalmoscope so that the live image 144a of the patient's retina 202 is shown on the display screen 116.

The smart-phone's LED light could be transmitted through the light transmission guide 16 in the housing 12 by a fiber optic cable 18 and projected through an axis coinciding with or very near to the optical axis of the above described lens system. One method for accomplishing this would be to project the light out of the fiber optic cable (or material with total internal reflectivity) onto a mirror 22 and through the pupil as shown in FIG. 1. To prevent leakage of light into the housing causing glare, a tight seal 20 would be provided around the smart-phone's light source 114 when the housing 12 attaches to the phone. This could be accomplished with an O ring or elastomeric material embedded in the plastic housing.

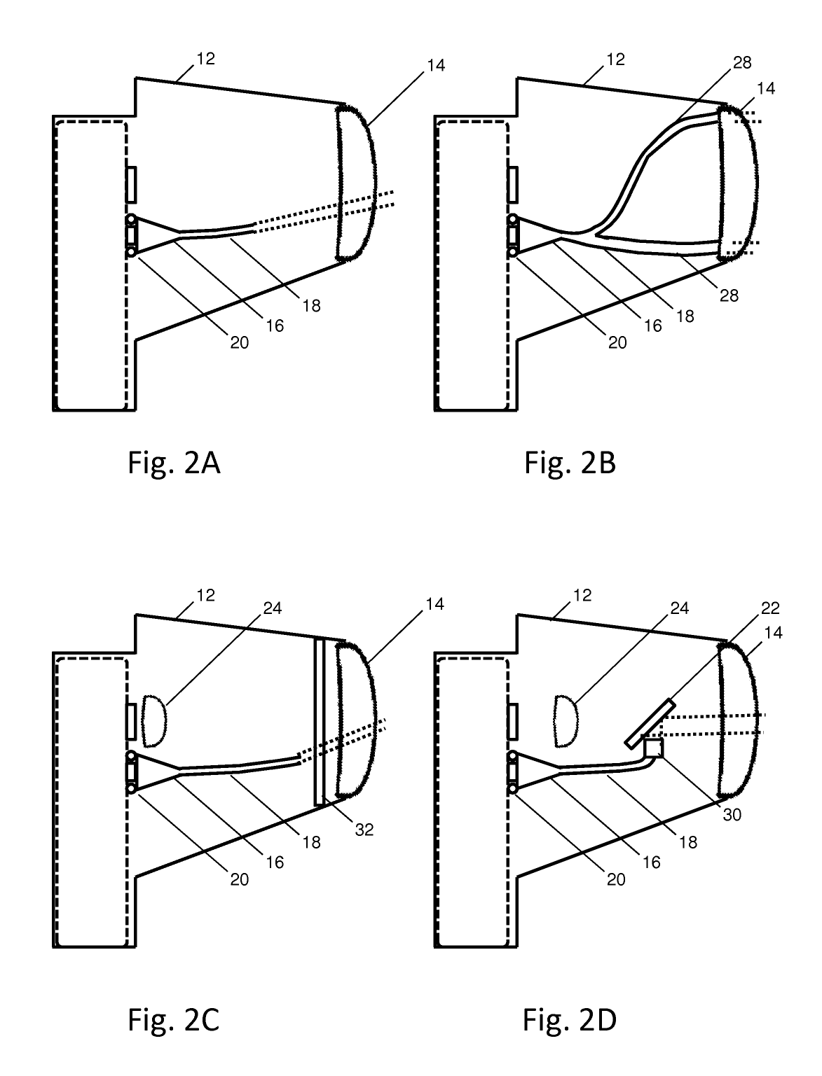

The purpose of the short piece of fiber optic tubing is to reduce the cone of expansion of the light source (collimating or otherwise focusing and directing the light), and this may be done without any mirror as shown in FIG. 2A. Ideally, the cone of expansion would be limited sufficiently as a result of passing thought the fiber optic tubing. A possible alternative to light transmission guide without any mirror is shown in FIG. 2B could use multiple fiber optic segments 28 to project the light to a ring shaped aperture or fiber bundle either just behind or just anterior to the objective lens. This type of system could have the advantage of causing less corneal glare than the above described system. Other lens and minor systems may alternatively be used to direct the light to the back of the eye. The length of the fiber optic cable can be varied as shown in FIG. 2C.

FIG. 2D shows a version of the light transmission guide 16 with a condensing lens 30 in optical communication with the fiber optic cable 18. A positive power lens with biconvex surfaces may also be used at the end of the fiber optic tube. The cone of expansion of the light should be constrained such that after passing through the objective lens, the focal point of the light would coincide with the secondary focal point of the objective lens. When light passes though the fiber optic cable, there is an inherent condensing that occurs. The fiber optic cable can decrease the vergence of the light coming from the smart-phone's light source and then project the light through the pupil and onto the patient's retina. The condensing effect may result in no other condensing lenses being added to the system which would reduce the complexity. It is also possible to fuse a gradient-index (GRIN) lens or condensing lens to the end of the optical fiber at the seal adjacent to the smart-phone's light source. The GRIN lens focuses the light from the LED to produce a collimated light as it enters the fiber optic segment.

Other methods of projecting light through the pupil are possible that may allow more conformity with Gullstrand' s Principle that illuminating rays of light should be projected onto the fundus through a different path than the path of the imaging rays to minimize reflections from crystalline lens and cornea which degrades image quality. Strict adherence to this principle may not be possible while imaging through an undilated pupil. Red filters 32 could be used within the optical system to decrease the percentage of color spectrum received that is in the red spectrum. This would increase image contrast while imaging the retina, as it is mostly pigmented red.

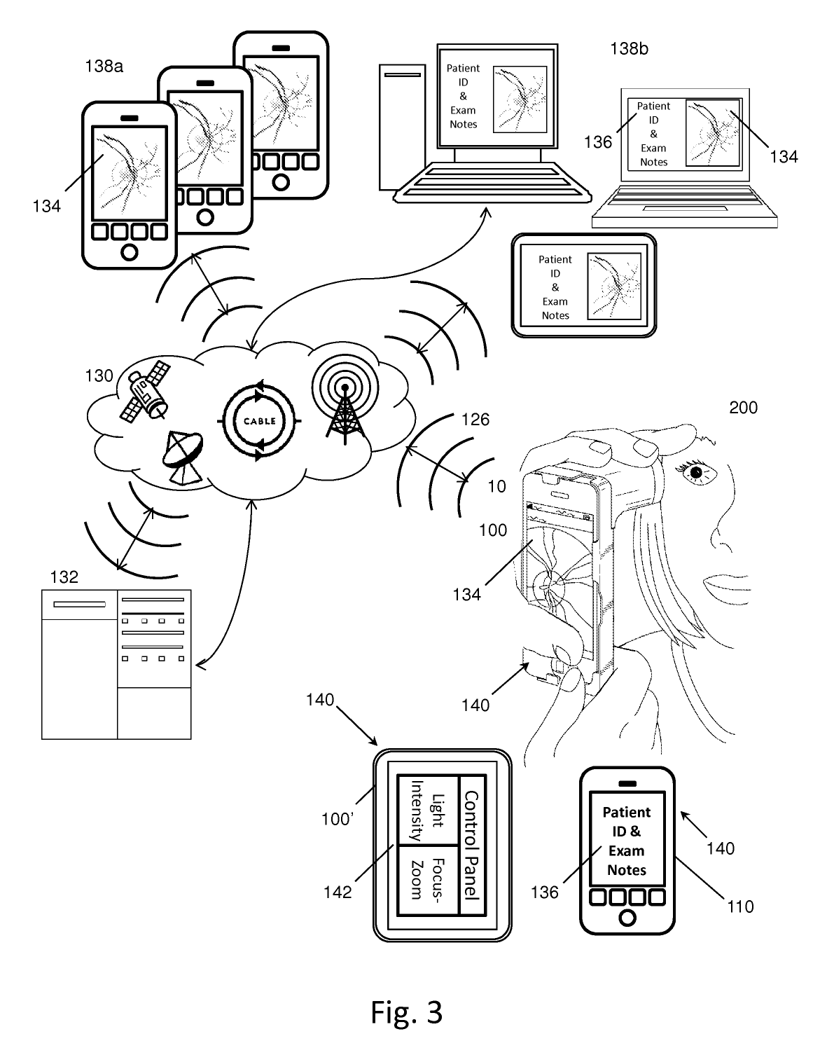

As illustrated in FIGS. 3-5 and described in detail below, the present invention can use the computing power 118 and communication abilities 120 of the smart-phone to produce a smart ophthalmoscope/fundus camera system 140 which can be integrated with specialized computer programs 142, such as control panels 148 and examination applications 150. The integrated smart-scope system 140 can be used for taking examination records and notes 136, annotating, processing and storing the images 134, and for sharing the images and corresponding information with other practitioners in a medical practice, a hospital system or remote locations through a communications network 130. The smart-scope system 140 can also use the speaker 122 and microphone 124 of the smart-phone 110 for taking and listening to voice notes, which may include capturing and replaying audio recordings with video recordings being made of the subject 200. Regardless of the adapter being used, the captured images 134 and other information 136 can be communicated to other smart-phones 138a or computers 138b using the smart-phone's communication link with one or more services on the communications network. In some cases, communication is made through a physical cable, such as a USB cable. In the preferred embodiment, the communication is made through a wireless transmission 126 from the smart-phone to the communications network 130 or a local computer by methods known to those skilled in the art. The apparatus can be linked with a centralized server 132 through the network 130 to send the captured images 134 and other information 136.

It will be appreciated that the combination of the optical adapter 10 with the smart-phone 110 allows a user to capture images of a patient's eye in out-of-office settings when it would be impractical for the user to transport traditional equipment capable of viewing and photographing an eye. The smart-scope system 140 also allows the user to communicate with specialists such as optometrists and ophthalmologists in a separate location for the purpose of diagnosing and evaluating a patient's eye. For example, an emergency room physician may use the smart-scope system 140 with the ophthalmological adapter to view and capture images of a patient's eye 200 and send them to an ophthalmologist to diagnose an injury to the patient's eye.

As described above, the images may be transferred to a network that is accessible by physicians for further analysis. The smart-scope system 140 can communicate images and patient records and information to a network of computers that are accessed by physicians and ophthalmologists for second opinions and assistance in diagnosing issues. Once the images are transferred to a computer, the images can be analyzed or electronically transferred again over the internet, a local network or other communications networks to specialists for analysis. Along with the image information that is transferred over the networked system, patient data and patient medical history may also be included to aid in the physician's analysis of the images.

The integration of the optical adapter 10 with one or more systems in the smart-phone 110 can also help the users of smart-scope systems 140 perform their examinations of the patients 200. The benefits of the smart-scope system 140 is exemplified with respect to ophthalmic examinations where it is often difficult for a clinician to obtain a good view of the retina through an undilated pupil for long periods of time which would typically be required for good photography. This is partially due to low patient tolerance for bright lights and limited ability to hold the ophthalmoscope perfectly steady. The latter half of this problem will be partially solved by the decreased weight and bulk of the adapter and smart-phone imaging system as described above relative to the weight and bulk of standard ophthalmoscopes and fundus cameras, but patient tolerance could still present challenges. To further help overcome the problem of patient tolerance to lights, the smart-scope system 140 can include adapter software 142 which runs on the smart-phone's computer processor and optimizes the use of the optical adapter fitting with the particular features of the smart-phone.

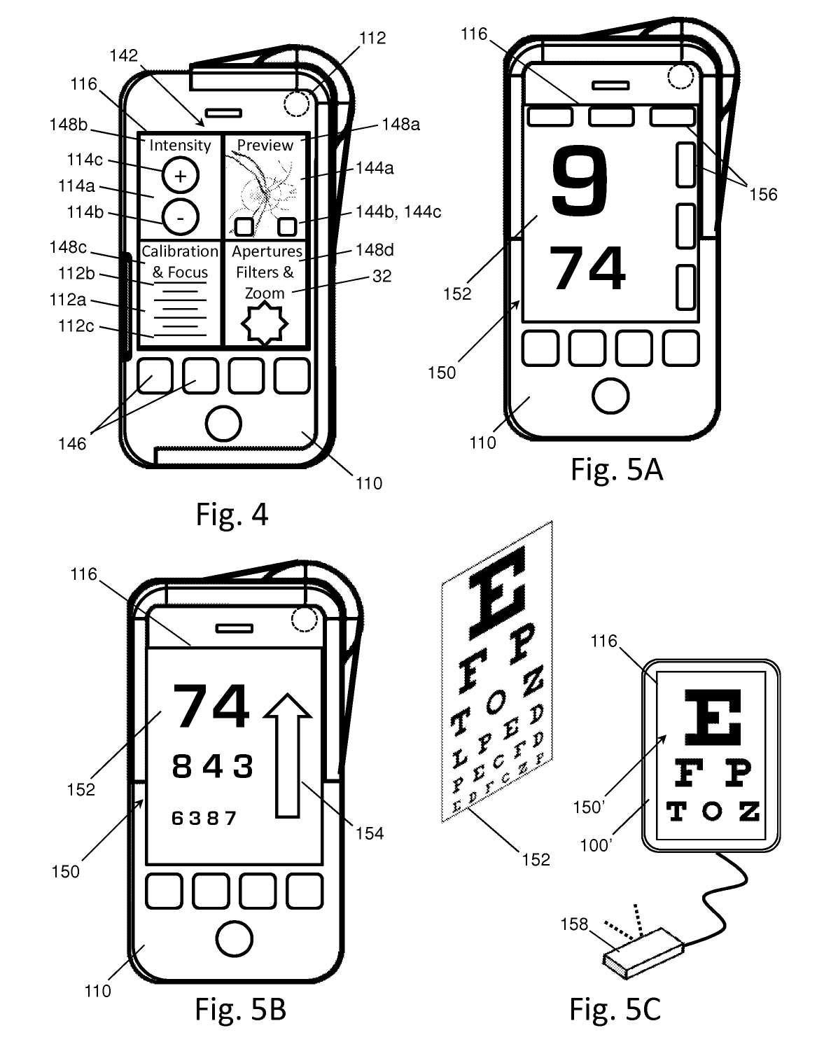

The computer processors 118 and display screens 116 of the smart-phone 110 can be used to optimize various functions of the smart-phone for use in combination with the optical adapter 10. Just as the optical features of the optical adapter described above are optimized for ophthalmologic examinations, the functions of the smart-phone can also be optimized for the particular use of the optical adapter. For example, as shown in FIGS. 3 and 4, one or more specialized computer program applications 142 running on the smart-phones can serve as control panels 148 for one or more of the image control selectors that can be individually selected by corresponding control buttons 146. The computer programs 142 optimize the use of the smart-phone 110 with an ophthalmologic optical adapter 10. Generally, the combination of the optical adapter 10 with the specialized computer program 142 produces an optical adapter system that is integrated with the smart-phone 110 to produce the smart-scope 140. Also, the computer programs 142 can calibrate the smart-phone systems to the particular type of optical adapter 10 for optimal use according to the specific tasks that are to be performed.

In the particular example of using the optical adapter system with the smart-phone as an ophthalmic viewing and examination device, the adapter software 142 may have an image preview screen for the live subject views 144a which could serve as an image selection control panel 148a with one or more capture image commands 144b, 144c for the smart-scope 140 to produce the captured image 134 from the live subject views 144a. One of the capture image commands 144b could instruct the processor 118 to capture of multiple images in series over a several second period to give the clinician the best chance possible of obtaining quality images. This option frees the clinician from the burden of having to interact with the smart-phone controls while aligning the smart-scope with the desired area of the retina to be viewed. The clinician may attempt to view the optic nerve for six (6) seconds, but only obtain a satisfactory view for one-half of a second. The computer program can also allow the user to select the frames during the period in which the system produced good images.

Other capture image commands 144c could be used to select or adjust a countdown time before the recording starts and/or adjust a preset recording time for capturing video images. The software can provide the user with default times, such as a countdown time of three (3) seconds and a recording time of five (5) seconds. The user can review images on the screen in real time and can replay the video and/or scroll through a series of freeze-frame images. The user can select one or more images and store high resolution version of the selected image. Settings functions in the computer program can be used to adjust an evaluation period, i.e., the countdown time before the recording starts, and can also be used to adjust a picture-taking mode, i.e., the recording time for capturing the images.

In addition to controlling the imaging portion of the smart-phone's camera system as explained above, it is also possible for the computer program 142 to have a light control panel 148b which controls the intensity 114a of the light 114 on the smart phone 110 to further optimize performance of the overall system. For example, when imaging the eye, the adapter software may reduce the intensity 114b of the smart-phone's light while the clinician aligns the device with the portion of fundus that is to be imaged. This could allow focusing of the camera with better patient tolerance. The light intensity could be momentarily increased 114c while images are actually captured. It will be appreciated that the the user may manually vary the intensity levels as well as set the intensity levels using light intensity control adjustments on the light control panel 148b.

The software 142 can also perform an initial analysis of the eye. For example, the computer program can calibrate the adapter fitting according to its operations with a particular smart-phone and then calculate the refractive error of the subject's eye based on the amount of focal power that is required by the camera system's focusing lens to obtain a focused image 148c. As described in further detail below, the adapter's lens system may be designed such that the camera's focusing lens uses a particular amount of focal power to obtain a clear image of an emetropic human eye. By knowing this baseline level of power that is required for focusing the image of an emetropic human eye, measuring the power level that is required to focus on a particular subject's eye, and having a correlation between the differential power levels and refractive errors of the subject's eye (myope and hyperope), the software can determine the refractive error.

The focal power of the adapter's lens system is preferably designed in an arrangement that causes the focusing lens within smart-phone camera (material that changes refraction index as voltage is applied) to use approximately one-half of its focal power to obtain a clear image of an emetropic human eye (i.e., no refractive error in the eye). Accordingly, the computer program can correlate the smart-phone's camera system with the adapter through a calibration factor 112a. This configuration would allow the smart-phone camera to automatically add or subtract focal power 112b, 112c and enable the clear imaging through a wide range of refractive errors in the lens of the subject's eye (myope and hyperope) with no additional focusing lenses required in the adapter, and these differential power levels can be correlated to the corresponding refractive errors.

As a particular example, the iPhone 4 camera has about 18 diopters of focal power, allowing it to focus a clear image at infinity down to about 2.5 inches. For the iPhone 4, the objective lens would require the iPhone to use approximately +8 diopters of refractive power to obtain a clear image on and emetropic eye. It will be appreciated that an additional or a different power objective lens could be added to the lens system for a wider field of view through a dilated pupil. The objective lens 14 would have an overall positive power, increasing the vergence of light passing through it. The convex anterior surface and concave posterior surface allow the objective lens to sit closer to the smart-phone lens for a more compact housing and give a wide angle field of view of the retina (the posterior pole, 25-40 degrees).

It may also be possible for the optical adapter 10 to also be powered and may have sensors that measure the settings of image control features, such as a focusing system, and aperture system and filters, as well as its own computer processor and communications module (not shown). In such a case, in addition to calculating the refractive error, the calibration and focusing program may provide another focusing control panel in which a user can manually adjust the focus through the optical adapter, and the measured settings may be communicated between the adapter and the smart-phone and used in the calculation of the refractive error. Additionally, an aperture and/or filter control panel 148d could be used to select a corresponding aperture or filter 32. It will also be appreciated that the zoom capabilities of the smart-phone could also be controlled through one or more of the control panels 148a, 148d. Additionally, it is possible to have additional zoom capability as a part of the optical adapter fitting.

With the ophthalmological adapter removably attached to the smart-phone 110 or other mobile communication/computation device 100, the smart-scope system 140 is able to capture images of the eye, including images of the retina and optic nerve. The image captured on the smart-scope system 140 has an image quality that is similar to the image that a practitioner would see when traditionally using an ophthalmoscope. The images may be viewed and analyzed either on the smart-scope system 140 or on a computer, as described below. In one embodiment, the smart-scope system 140 can take still images. In another embodiment, the smart-scope system 140 may record video images with or without an audio recording. In yet another embodiment, the smart-scope system 140 can take still images and video images.

The smart-scope system 140 may have its own software for an initial analysis of the images obtained using the ophthalmological adapter. The software can link stored images with patient identifiable information (PII), date and time information and examination record and notes. The software can provide step-by-step instructions for taking the pictures as well as performing associated tests. For example, in the ophthalmological system, the software could lead the user through an eye examination which may include entering results from visual acuity testing, intraocular pressure testing, visual fields testing, pupil function testing, ocular motility testing, and cobalt blue light for external examination. The user can enter the PII into the application's data storage through a screen that links all of the patient's information and the results from the tests together in an electronic medical record for the patient.

In the visual acuity test 150, as shown in FIGS. 5A-5C, the examination application 150 can display an electronic version of a visual acuity chart 152 on the screen 116 of the smart-phone 110. The software sizes the display so that the optotypes are scaled for the near-vision test to be performed at a standard distance, such as fourteen (14) inches from the patient being tested. The user performing the examination can scroll the screen 154 to display different sized optotypes, and the user can also select test results buttons 156 on the screen. The buttons can include selections for each one of the optotype scales as well as options for when the patient cannot read any optotype on the chart, including buttons for counting fingers, hand motion, light perception, and no light perception.

As indicated above and particularly shown in FIGS. 3 and 5, it is possible to resize the adapter for use with various mobile communication/computation devices that have integral camera systems. A tablet computer 100′ may be more desirable for certain uses in which a larger display may be more desirable, or for certain users, such as with academic instructors in educational environments where the computer systems may already have tablet computers in the laboratories. Of course, the orientation of the tablet computer can be vertical or horizontal, as can the orientation of most smart-phones, and adapters can be made to accommodate either orientation. Such modifications to the size and orientation of the adapter for various mobile communications devices are a matter of design choice, and it should be appreciated that indications of particular mobile communications devices, such as a smart-phone, a tablet computer or a digital camera, is an exemplary description and is not limiting to the scope of this invention.

In FIGS. 5A and 5B, the examination computer program 150 is run on a smart-phone. In FIG. 5C, another examination computer program 150′ is run on a tablet computer 100′. Also, as shown in FIG. 5C, the smart-phone 110 or communication/computation device 100 can transmit the visual acuity chart 152 through a projection system 158 onto a wall or screen to perform a distant-vision examination.

With the ability of the smart-scope to communicate with other computers, it is possible for the programs 142 to run on different mobile communication/computation devices 100 during the same procedure for a particular patient. For example, a medical practitioner may operate the set of adapter control panel programs 148 on the smart-phone 110 while examining the patient's eyes while running the examination program 150 on a tablet computer 100′ and the results of the examination from both of the mobile communication/computation devices could be uploaded directly to the patient's electronic medical records (EMR) on a server computer 132.

It will also be appreciated that a computer may have software for analyzing the images obtained by smart-scope systems 140. and that other optical adapters can be removably attached to the smart-phone 110 or other mobile communication/computation device 100 to facilitate the viewing and capturing of images of a patient's ear, nose, or throat. Each one of these alternative systems would be a smart-scope system 140 within the meaning of the present invention.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. For example, for applications of the present invention to serve as other types of scopes, the light transmission guide 16 could direct the light out of the housing through one or more holes in the sides of the housing rather than through the lens. Thus, the breadth and scope of the present invention should not be limited by any of the above-described exemplary embodiments, but should be defined only in accordance with the following claims appended hereto and their equivalents.

What is claimed is:

1. An optical adapter system for a smart-phone having an imaging system with a camera lens and a light source, a computer processor, and a communications module, comprising:
a housing removably attached to the smart-phone at a proximal end and extending away from said proximal end to a distal end, wherein said proximal end surrounds the camera lens and the light source;
a lens fixedly connected to said distal end of said housing, wherein said lens is located in a fixed position in optical alignment with the camera lens; and
a light transmission guide fixedly connected to said housing, wherein said light transmission guide extends from a first end adjacent to the light source at said proximal end of said housing toward said distal end of said housing at a second end.

2. The invention of claim 1, wherein said light transmission guide further comprises a seal at said first end surrounding the light source.

3. The invention of claim 2, wherein said light transmission guide further comprises at least one of a GRIN lens, a condensing lens, a fiber optic cable, and a plurality of fiber optic segments.

4. The invention of claim 1 further comprising an eye-piece lens in optical alignment between said lens and the camera lens.

5. The invention of claim 1 further comprising a mirror in optical alignment between said second end of said light transmission guide and said lens.

6. The invention of claim 1 further comprising a computer program running on the computer processor, wherein said computer program determines a calibration factor for the imaging system in the smart-phone according to said lens in said housing.

7. The invention of claim 6, wherein said computer program further comprises a visual acuity test screen.

8. The invention of claim 6, wherein said computer program further comprises a control module for powering the light source for an evaluation period, and wherein said light transmission guide directs light from the light source to a subject at an exterior of said housing.

9. The invention of claim 8, wherein said evaluation period is a greater period of time than a picture-taking mode setting for the imaging system, and wherein said computer program further comprises a countdown time before recording images through the imaging system.

10. The invention of claim 8, wherein said subject is an interior portion of an eye, wherein said computer program further comprises a calculation of a differential power level in the imaging system between focusing of said subject eye and focusing of an emetropic eye.

11. The invention of claim 10, wherein said computer program further comprises a determination of a refractive error in said subject eye based on said differential power level.

12. The invention of claim 8, wherein said computer program produces a plurality of control panel displays, said control panel displays comprising an image preview with a plurality of live subject views received by the imaging system through said lens, an image control selector corresponding with said imaging system, and a capture image command for the imaging system to produce a captured image from at least one of said live subject views.

13. An optical adapter system for viewing and capturing images of a subject, comprising:
a smart-phone comprising an imaging system, a computer processor, a memory and a wireless communications module, said imaging system having a camera lens, a light source and a display screen;
an optical adapter fitting comprising a housing, a lens and a light transmission guide, wherein said housing is removably attached to said smart-phone at a proximal end and extends away from said proximal end to a distal end, wherein said proximal end surrounds said camera lens and said light source, wherein said lens is fixedly connected to said distal end of said housing and is located in a fixed position in optical alignment with said camera lens, and wherein said light transmission guide directs light from said light source to an exterior side of said housing; and
a computer program running on said computer processor and configured to operate said imaging system of said smart-phone in relation to said optical adapter fitting, wherein said computer program comprises a control module for powering said light source and for producing a live subject view on said display screen.

14. The invention of claim 13, wherein said light transmission guide further comprises a seal at said first end surrounding the light source and wherein said directed light from said light source is aimed toward a subject located at said exterior side of said housing.

15. The invention of claim 14, further comprising an eye-piece lens and a minor, wherein said eye-piece lens is situated within said housing in optical alignment between said camera lens and said lens in said adapter, wherein said mirror is situated within said housing in optical alignment between said second end of said light transmission guide and said lens, and wherein said light transmission guide further comprises at least one of a GRIN lens, a fiber optic cable extending from said seal toward said lens, and a plurality of fiber optic segments extending a plurality of paths to locations around a periphery of said lens.

16. The invention of claim 13, wherein said live subject view is a subject eye, wherein said computer program further comprises a calculation of a differential power level in said imaging system between focusing of said subject eye and focusing of an emetropic eye, and wherein said computer program further comprises a determination of a refractive error in said subject eye based on said differential power level.

17. The invention of claim 13, wherein said control module powers said light source for an evaluation period, and wherein said computer program further comprises a countdown time for said evaluation period before recording a plurality of images in said memory during a picture-taking time.

18. The invention of claim 17, wherein said control module increases a light intensity of said light source during said picture-taking time.

19. A method for using an optical adapter system with a smart-phone having an imaging system with a camera lens, a light source, a display screen and a data storage, a computer processor, and a communications module, comprising the steps of:
attaching an optical adapter fitting to the smart phone, wherein said optics comprises a housing, a lens and a means for directing light from the light source to an exterior side of said housing through said lens, wherein said housing is removably attached to the smart-phone at a proximal end and extends away from said proximal end to a distal end, and wherein said proximal end surrounds the camera lens and the light source, wherein said lens is fixedly connected to said distal end of said housing and is located in a fixed position in optical alignment with the camera lens;
powering the light source for an evaluation period, wherein said evaluation period is a greater time than a picture-taking period;
displaying an object on the display screen during said evaluation period;
providing a countdown time before recording images of said object; and
recording a plurality of images of said object in the data storage.

20. The invention of claim 19, further comprising the step of increasing a light intensity of the light source as said images are being recorded.
